(19) United States
(12) Patent Application Publication
(10) Pub. No.: US 2010/0100303 A1
(43) Pub. Date: Apr. 22, 2010

(54) Fuel Injection Control Device For Diesel Engine

(75) Inventors: Keiichiro Yuzaki, Osaka (JP); Tomohiro Ootani, Osaka (JP)

Correspondence Address: STERNE, KESSLER, GOLDSTEIN & FOX P.L.L.C., 1100 NEW YORK AVENUE, N.W., WASHINGTON, DC, 20005, US

(73) Assignee: Yanmar Co., Ltd., Osaka (JP)

(21) Appl. No.: 12/529,860

(22) PCT Filed: Mar. 4, 2008
(86) PCT No.: PCT/JP2008/053806

§ 371 Date: Sep. 3, 2009

(30) Foreign Application Priority Data
Mar. 5, 2007 (JP) 2007-54596
Mar. 5, 2007 (JP) 2007-54597

(51) Int. Cl. F02D 41/30; F02M 63/00

(52) U.S. Cl. 701/103; 123/447

(57) ABSTRACT

A fuel injection control device for a diesel engine controls the first fuel injection timing so as to reduce the amount of white smokes generated in large amounts immediately after starting an engine. The fuel injection control device for the diesel engine comprised a high-pressure pump, a common rail for accumulating a highly-pressured fuel, injectors for injecting the fuel into a combustion chamber and a control means. Due to the fuel injection control device for the diesel engine, the fuel injection is performed after the cranking, without injecting the fuel for a certain period of time after an engine staring switch is turned on, in order that the pressure in the common rail becomes a setting value.

### BACKGROUND OF THE INVENTION

1. Field of the Invention

The present invention relates to a fuel injection control device for a diesel engine, and more specifically relates to a fuel injection control device for a diesel engine for controlling the first fuel injection command soon after a cranking at the time of starting the engine.

2. Related Art

A fuel injection control device for a diesel engine includes a common-rail fuel injection control device. In the common-rail fuel injection control device, fuel is accumulated into a common rail by a high-pressure pump, and the fuel is injected from an injector into a combustion chamber by opening and closing a solenoid valve. Fuel injection timing and fuel injection quantity are controlled by energization of the solenoid valve in the injector, depending on the specified engine rotating speed, the load or the like. A cranking is started by a starter, and then a cylinder engine in which the fuel is firstly injected is determined by a cylinder engine determining sensor as well as a fuel injection command signal is issued from an engine control unit (hereinafter, referred to as “ECU”) to the solenoid valve in the injector, whereby the engine is started. Briefly, the fuel injection is started immediately after the cranking has been started and the cylinder engine is determined. In order to early increasing a rail pressure of the common rail at the time of starting the engine, a discharge rate of the fuel from the high-pressure pump is set up to be maximized shortly after the cranking. With regard to the common-rail fuel injection device as mentioned above, the following fuel injection devices are disclosed, wherein the fuel injection is divided into a main injection and a pilot injection before the main injection, so as to slack a combustion by the main injection (for example, see Patent Literature 1), so as to control the pilot injection (for example, see Patent Literature 2) or so as to reduce the amount of white smoke at the time of starting the engine by further injecting a small amount of fuels before the pilot injection or the like (for example, see Patent Literature 3).

### Patent Literature 1: the Japanese Patent Laid Open Gazette 3473211

### Patent Literature 2: the Japanese Patent Laid Open Gazette 3418996

### Patent Literature 3: the Japanese Patent Laid Open Gazette 3580099

### DISCLOSURE OF INVENTION

### Problems to be Solved by the Invention

In the conventional fuel injection control device as described above, the fuel injection is started soon after the cranking, and the time from immediate aftermath of the cranking till the initiation of the fuel injection is not controlled.

When the fuel is injected before reaching a given injectable common rail pressure, the injection from the injector into the combustion chamber becomes unstable. When the fuel is injected into the combustion chamber on the condition that the combustion chamber is at low temperature just after the cranking, the fuel is not fully evaporated, so that a large amount of fuels having no contribution to the combustion is accumulated into the combustion chamber. Since the fuels accumulated into the combustion chamber is discharged from the combustion chamber at once when the ignition is performed thereafter, whereby a great deal of white smokes are generated immediately after starting the engine.

Because the fuels are leaked from the injector, the time until the common rail pressure reaches the given injectable pressure becomes longer, thereby lengthening the time until starting the engine.

In consideration of the aforementioned problems, it's an object of the present invention to provide a fuel injection control device for a diesel engine that can control the first fuel injection timing and that can reduce the amount of white smokes generated in large amounts soon after starting the engine.

### SUMMARY OF THE INVENTION

### Means for Solving the Problem

In order to achieve the above-mentioned objects, in the first embodiment of the present invention, a fuel injection control device for a diesel engine comprises a high-pressure pump, a common rail for accumulating a highly-pressured fuel pressurized and sent from the high-pressure pump, injectors for injecting the fuel supplied from the common rail into a combustion chamber, and a control means for controlling the injectors to perform the first fuel injection command soon after a cranking, after a rail pressure of the common rail reaches a predetermined pressure.

Due to the above construction, the fuel having no contribution to the combustion generated due to lack of the rail pressure is not leaked and accumulated into the combustion chamber. The amount of fuels leaked from the injector is reduced and the time until the rail pressure reaches the injectable pressure is shortened.

With respect to the second embodiment of the present invention, in addition to the first embodiment, the fuel injection control device for the diesel engine further comprises a detecting means for detecting an engine temperature, and a setting means for setting up the predetermined pressure based on the detected engine temperature.

Due to the above construction, the setting pressure is varied depending on the engine temperature.

With respect to the third embodiment of the present invention, in the second embodiment, the engine temperature is calculated based on at least a coolant water temperature.

Due to the above construction, the setting pressure is varied depending on the coolant water temperature of the engine.

With respect to the fourth embodiment of the present invention, the fuel injection control device for the diesel engine further comprises a starter starting an operation by turning on an engine starting switch, a setting means for setting up a non-fuel injection time when the cranking is continuously performed by the starter using a battery power, and a control means for controlling the injectors to perform the first fuel injection command after the lapse of the non-fuel injection time.

Due to the above construction, the temperature in the combustion chamber is increased due to the cranking during the non-fuel injection time, and the rail pressure of the common rail is increased during the non-fuel injection time.

With respect to the fifth embodiment of the present invention, in the fourth embodiment, the fuel injection control device for the diesel engine further comprises a detecting means for detecting the engine temperature, wherein the non-fuel injection time is set up based on the detected engine temperature.

Due to the above construction, the non-fuel injection time is varied depending on the engine temperature.

With respect to the sixth embodiment of the present invention, in the fifth embodiment, the engine temperature is calculated based on at least the coolant water temperature.

Due to the above construction, the non-fuel injection time is varied depending on the coolant water temperature.

With respect to the seventh embodiment of the present invention, in the fourth embodiment, when the non-fuel injection time is longer than the continuous cranking available time, the cranking is performed without injecting the fuel during the continuous cranking available time and wherein the setting means newly sets up the non-fuel injection time after the cranking is stopped.

Due to the above construction, a battery power is stable without being rapidly decreased, and continuous operating time of the starter does not become longer than the predefined time.

With respect to the eighth embodiment of the present invention, in the seventh embodiment, re-cranking performed during the non-fuel injection time newly set up is automatically started.

Due to the above construction, re-cranking is repeated until the engine is started.

With respect to the ninth embodiment of the present invention, in the fourth embodiment, the fuel injection command is issued to the injector attached to the cylinder engine having the highest intake air temperature.

Due to the above construction, the first explosion is easy to be performed, and compression end temperature of cylinder engine in which the fuel is secondly injected is increased due to the torque by the cylinder engine in which the first explosion was made, thereby enhancing the ignition.

With respect to the tenth embodiment of the present invention, in the fourth embodiment, pressure feeding quantity of the fuel pressurized and sent from the high-pressure pump per unit time is reduced, so that the time until the fuel injection command is issued approximately coincides with the one until the rail pressure of the common rail reaches a target pressure.

Due to the above construction, the fuel pressure feeding quantity from the high-pressure pump to the common rail just after starting the cranking needs not to be maximized.

With respect to the eleventh embodiment of the present invention, in the fourth embodiment, the setting means and the control means are set up so as not to be performed, when voltage of the battery is a predetermined value or lower.

Due to the above construction, excessive burdens are not placed on the battery.

### EFFECT OF THE INVENTION

As described above, according to the first embodiment of the present invention, because the fuel having no contribution to the combustion generated due to lack of the rail pressure is not accumulated into the combustion chamber, the amount of white smokes generated in large amounts soon after starting the engine can be reduced. The amount of fuels leaked from the injector is reduced and the time until the rail pressure reaches the injectable pressure is shortened, so that the time until the engine is started can be shortened.

According to the second embodiment of the present invention, in addition to the effect of the first embodiment, since the setting pressure is varied depending on the engine temperature, the white smoke is reduced and the optimal engine starting time is set up, so that efficient engine starting can be performed.

According to the third embodiment of the present invention, in addition to the effect of the second embodiment, since the setting pressure is varied depending on the coolant water temperature, the engine temperature most suitable for starting the engine can be calculated and more efficient engine starting can be performed.

According to the fourth embodiment of the present invention, as the temperature in the combustion chamber is increased due to the cranking during the non-fuel injection time and the rail pressure of the common rail is increased during the non-fuel injection time, the fuel having no contribution to the combustion accumulated into the combustion chamber in the first fuel injection can be decreased, whereby the amount of white smokes generated in large amounts soon after starting the engine can be reduced.

According to the fifth embodiment of the present invention, in addition to the effect of the fourth embodiment, since the non-fuel injection time is varied depending on the engine temperature, the white smoke is reduced and the optimal engine starting time is set up, so that efficient engine starting can be performed.

According to the sixth embodiment of the present invention, in addition to the effect of the fifth embodiment, since the non-fuel injection time is varied depending on the coolant water temperature, the engine temperature most suitable for starting the engine can be calculated and more efficient engine starting can be performed.

According to the seventh embodiment of the present invention, the battery power is stable without being rapidly decreased, and continuous operating time of the starter does not become longer than the predefined time, so that the burdens on the battery or the starter can be reduced.

According to the eighth embodiment of the present invention, in addition to the effect of the seventh embodiment, since re-cranking is repeated until the engine is started, an operator needs not to turn on the engine starting switch again and again, thereby improving the usability.

According to the ninth embodiment of the present invention, in addition to the effect of the fourth embodiment, since the first explosion is easy to be performed, and compression end temperature of cylinder engine in which the fuel is secondly injected is increased due to the torque by the cylinder engine in which the first explosion was made, as well as the ignition is enhanced, the fuel having no contribution to the combustion accumulated into the combustion chamber can be decreased, whereby the amount of white smokes generated in large amounts soon after starting the engine can be further reduced.

According to the tenth embodiment of the present invention, in addition to the effect of the fourth embodiment, since the fuel pressure feeding quantity from the high-pressure pump to the common rail just after starting the cranking needs not to be maximized, the driving force of the high-pressure pump needed soon after starting the cranking can be reduced. The burden on the starter can be lowered, whereby the cranking rotation speed is increased.

According to the eleventh embodiment of the present invention, in addition to the effect of the fourth embodiment, the excessive burdens on the battery are decreased, so that the impossibility of starting the engine can be avoided.

### BRIEF DESCRIPTION OF THE DRAWINGS

FIG. 1 is a block diagram illustrating a schematic construction of a fuel injection control device for a diesel engine according to the first embodiment of the present invention.

FIG. 2 is a flow diagram illustrating a behavior of a fuel injection control according to the first embodiment of the present invention.

FIG. 3 is a time chart illustrating a relationship between a cranking, an energization of a solenoid valve and the non-fuel injection time, wherein FIG. 3 (1) and (2) are time charts in the fuel injection control device for the diesel engine as shown in FIG. 1 and FIG. 3 (3) is a time chart in the conventional fuel injection control device for the diesel engine.

FIG. 4 (1) is a diagram illustrating a relationship between white smoke concentration and coolant water temperature Tw in the conventional fuel injection control device for the diesel engine. FIG. 4 (2) is a diagram illustrating a relationship between the white smoke concentration soon after starting the engine and the non-fuel injection time tq as shown in FIG. 2. FIG. 4 (3) is a diagram illustrating a relationship between the non-fuel injection time tq as shown in FIG. 2 and the coolant water temperature Tw.

FIG. 5 is a diagram illustrating a relationship between a target pressure arrival time of the rail pressure in the common rail and the fuel pressure feeding quantity per unit time from the high-pressure pump, in the fuel injection control device for the diesel engine as shown in FIG. 1.

FIG. 6 is a flow diagram illustrating a behavior of a fuel injection control according to the second embodiment of the present invention.

FIG. 7 is a diagram illustrating a relationship between the common rail pressure, the energization of the solenoid valve and the opening/closing of a needle valve as well as time, wherein FIG. 7 (1) is a diagram in the fuel injection control device for the diesel engine as shown in FIG. 1 and FIG. 7 (2) is a diagram in the conventional fuel injection control device for the diesel engine.

FIG. 8 (1) is a diagram illustrating a relationship between the setting rail pressure P1 and the coolant water temperature Tw as shown in FIG. 6. FIG. 8 (2) is a diagram illustrating a relationship between the white smoke concentration and the coolant water temperature Tw in the conventional fuel injection control device for the diesel engine.

### DETAILED DESCRIPTION OF THE INVENTION

Next, embodiments of the present invention will be described with reference to drawings.

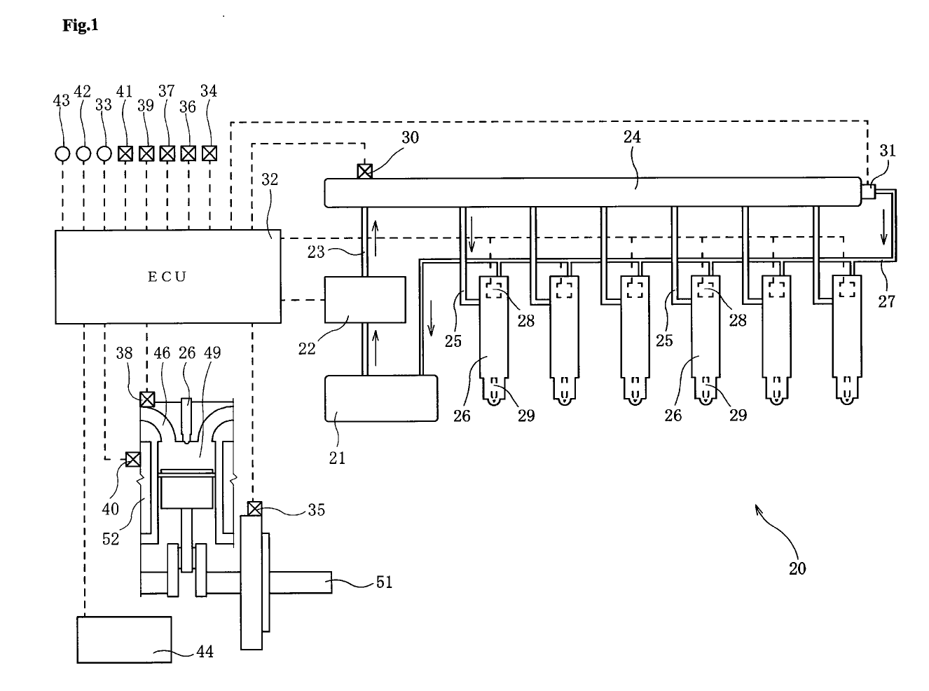

FIG. 1 is a block diagram illustrating a schematic construction of a fuel injection control device for a diesel engine according to the first embodiment of the present invention.

Referring to FIG. 1, a fuel injection control device for a diesel engine 20 comprises a fuel tank 21, a high-pressure pump 22 that inhales suitable amount of fuels from the fuel tank 21 and that sends high-pressure fuels through a fuel supply pipe 23 into a common rail 24, the common rail 24 that accumulates the high-pressure fuels, injectors 26 that injects the high-pressure fuels fed from the common rail 24 through fuel high-pressure pipes 25 into a fuel chamber 49, a starter 44 for performing a cranking, an ECU 32 as a control means for controlling them and various sensors or the like.

The common rail 24 includes a rail pressure sensor 30 and a pressure regulating valve 31. The ECU 32 detects a fuel pressure in the common rail 24 by the rail pressure sensor 30, and the fuel pressure is always regulated to an optimal pressure by opening or closing the pressure regulating valve 31. In other words, a stable injection pressure can be secured when an engine rotates at low speed and so on, regardless of an engine rotation speed or a load.

The respective injectors 26, which is provided with each of cylinder engines, includes a solenoid valve 28 that opens or closes by an ON/OFF signal from the ECU32 and a needle valve 29 for injecting the fuels into the fuel chamber 49 at high pressure. When the solenoid valve 28 is energized and is opened, a part of the high-pressure fuels flow out to a surplus fuel pipe 27, and the pressure behind the needle valve 29 is lowered so as to move up the needle valve 29 and open it, so that the fuel injection is performed. When the energization to the solenoid valve 28 is stopped, the high-pressure fuels are supplied behind the needle valve 29 again so as to move down the needle valve 29 and close it, so that the fuel injection is terminated. In the common rail fuel injection control device 20, the ECU 32 issues a signal to each of the solenoid valves 28 of the injectors 26, whereby the fuel injection timing and an injection quantity is controlled.

The ECU32 controls the fuel injections by the injectors 26, based on signals from the various sensors, internal program and data. The ECU32 controls the high-pressure pump 22, and calculates a target pressure for the common rail 24 based on the engine condition, as well as adjusts the amount of the high-pressure fuels for supplying to the common rail 24, so that an output from the rail pressure sensor 30 becomes the target value. The ECU32 is electrically connected to various sensors, such as a cylinder engine determining sensor 34 provided with a camshaft, an engine rotation speed sensor 35 provided with a crankshaft 51 or a flywheel, an acceleration opening degree sensor 36, an intake pressure sensor 37, an intake temperature sensor 38 provided with an intake port 46, a fuel temperature sensor 39, a coolant water temperature sensor 40 provided with a water jacket 52 formed outside of the combustion chamber 49 and a lubricant oil temperature sensor 41, including an engine starting switch 33 that transmits a starter signal to the ECU 32 and the starter 44. The ECU32 also includes a non-fuel injection time setting means 42 for setting up the after-mentioned non-fuel injection time tq and a battery voltage detecting means 43 for detecting a battery voltage (not shown). The ECU32 controls the engine by the signals transmitted from the aforementioned various sensors or the like.

Next, the first embodiment of a fuel injection control at the time of starting the engine will be described.

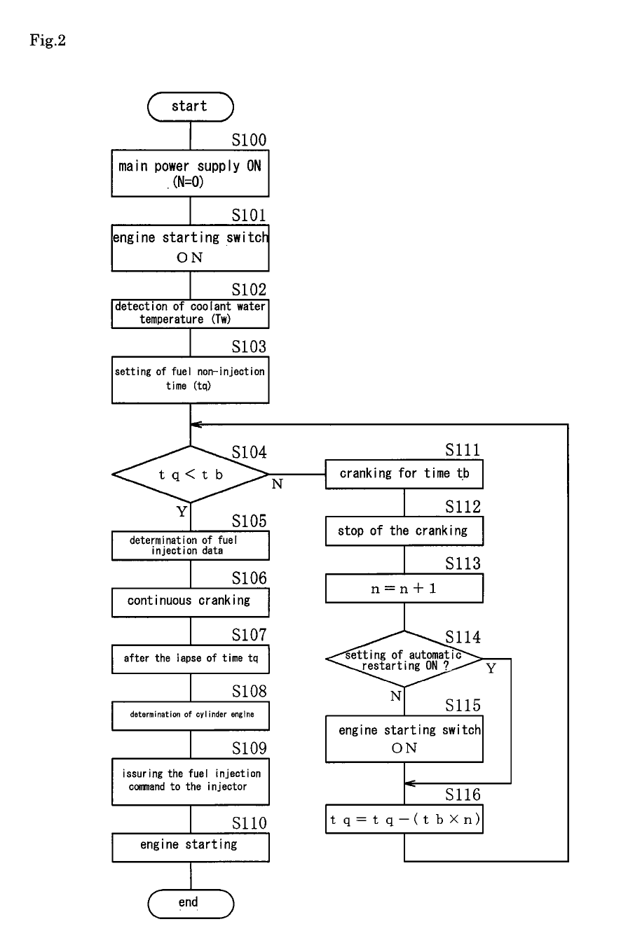

FIG. 2 is a flow diagram illustrating a behavior of the fuel injection control according to the first embodiment of the present invention.

Referring to FIG. 2, when a main power supply of the ECU 32 is turned on (S 100, n=0), an operator turns on the engine starting switch 33 (S 101).

The ECU32 detects the coolant water temperature Tw as the engine temperature by the signal from the coolant water temperature sensor 40 (S 102). The ECU32 sets up the non-fuel injection time tq when a fuel injection command is not issued in a given period of time by the non-fuel injection time setting means 42, based on the coolant water temperature Tw detected at the Step S 102 (S 103). The non-fuel injection time tq is set up to be longer as the coolant water temperature Tw is lower. When the non-fuel injection time tq set up at the Step S 103 is shorter than a continuous cranking available time tb, i.e., tq<tb (tq is smaller than tb), (Yes, at S 104), fuel injection data such as the fuel injection timing, the fuel injection quantity and the fuel injection pattern are determined (S 105). The aforementioned continuous cranking available time tb is a predetermined time calculated by continuous operating time of the starter 44 or, limitation to rapid depletion of the battery power or the like, which is preliminarily set up. The cranking is continuously performed by the operation of the starter 44 using the battery power (S 106). When the non-fuel injection time tq set up at the Step S 103 goes by (S 107), the ECU32 determines the cylinder engine in which the intake air temperature is mostly increased by the signal from the cylinder engine determining sensor 34 (S 108). The ECU32 issues the first fuel injection command to the injector 26 attached to the cylinder engine determined at the Step S 108 (S 109). The fuel injection is started, by energizing the solenoid valve 28 of the injector 26, and the engine is started (S 110).

In this regard, the cylinder engine in which the intake air temperature is mostly increased as mentioned above means the cylinder engine closest to a means for warming the intake air at the engine starting at low temperature. For example, when multiple cylinder engines are arranged in series as the present embodiment, an air heater as the means for warming the intake air is disposed at an inlet for the intake air of an intake manifold. Because the intake air warmed by the air heater is supplied to the respective cylinder engines, the cylinder engine closest to the mounting location of the air heater becomes the cylinder engine in which the intake air temperature is mostly increased.

Meanwhile, when it is not tq<tb at the Step S 104 (No, at S 104), the cranking is continuously performed for the above-mentioned tb time (S111), and the cranking is stopped once (S 112). Since the cranking is stopped, the battery voltage is recovered. Next, in case of n=n+1, i.e., n=1 (S 113), the operator turns on the engine starting switch again (S 115, No, at S 114,). In this regard, when an automatic restart is set up, the operator needs not turn on the engine starting switch again, and the Step S 115 is omitted (Yes, at S 114). The ECU 32 newly sets up the non-fuel injection time (tq−(tb×n)), i.e., (tq−(tb×1) (S 116). Retuning to the Step S 104 again, when, tq<tb with respect to the non-fuel injection time tq newly set up at the Step S 116 (Yes, at S 104), after the fuel injection data is determined (S 105), re-cranking is performed (S 106). When the non-fuel injection time tq newly set up at the Step S 116 goes by (S 107), as with the case of n=0, the determination of the cylinder engine (S 108) and the first fuel injection command to the injector 26 (S 109) are performed, so that the engine is started due to the fuel injection (S 110). Until the non-fuel injection time tq newly set up satisfies a condition tq<tb (Yes, at S 104), the continuous cranking for the tb time is repeated (S 111 to S 116, No, at S 104).

Incidentally, when the main power supply of the ECU 32 is turned on, the ECU 32 detects the battery voltage for use in the fuel injection control device for the diesel engine 20, by the battery voltage detecting means 43. When the detected battery voltage is a predetermined value or low, the ECU 32 sets up so that the fuel injection control is not performed, before the engine starting switch is turned on at the Step S 101. Due to the above setting, the excessive burden is not placed on the battery, whereby the incapability of the engine starting can be avoided.

Next, explanation will be given on the relationship between the cranking, the energization of the solenoid valve and the non-fuel injection time tq in the fuel injection control at the time of starting the engine as described above.

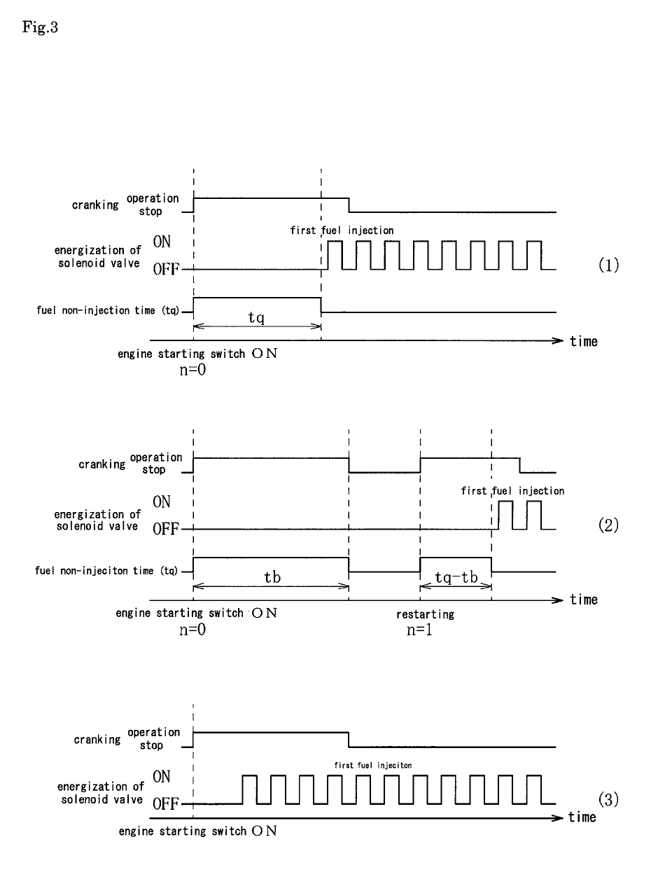

FIG. 3 is a time chart illustrating a relationship between a cranking, an energization of a solenoid valve and the time when a fuel is not injected, wherein FIG. 3 (1) and (2) are time charts in the fuel injection control device for the diesel engine as shown in FIG. 1 and FIG. 3 (3) is a time chart in the conventional fuel injection control device for the diesel engine.

Referring to FIG. 3 (1), the lapse time after the engine starting switch is turned on is used as the axis of abscissas, which shows the operating or stopping condition of the cranking, the ON/OFF condition of the solenoid valve and the non-fuel injection time tq from the top. FIG. 3 (1) shows the case of n=0 and tq<tb (Yes, at S 104 in FIG. 2) in the flow diagram as shown in FIG. 2. When the engine starting switch is turned on, the starter operates and the cranking is started, so that the solenoid valve 28 is firstly energized after the lapse of the non-fuel injection time tq. The fuel is injected and ignited due to the first energization of the solenoid valve 28, whereby the first explosion is performed.

Referring to FIG. 3 (2), FIG. 3 (2) is the time chart having the same construction as FIG. 3 (1), and is the case where n is zero and tq is not smaller than tb (No, at S 104 in FIG. 2), and where n is 1 and tq is smaller than tb (Yes, at S 104 in FIG. 2). When the engine starting switch is turned on, the starter operates and the cranking is started, so that the cranking is stopped as soon as the continuous cranking available time tb goes by. After the lapse of the predetermined time, the starter operates again and re-cranking is started, whereby the solenoid valve 28 is firstly energized, after the lapse of the non-fuel injection time (tq−tb) newly set up. As with the case of FIG. 3 (1), the fuel is injected and ignited due to the first energization of the solenoid valve 28, whereby the first explosion is performed.

Referring to FIG. 3 (3), in case of the conventional fuel injection control device for the diesel engine, the energization to the solenoid valve is performed just after staring the cranking, and the fuel is injected and ignited, whereby the first fuel explosion is performed after the energization is repeated at several times.

Explanation will be given on the relationship between the white smoke concentration and the coolant water temperature Tw, the relationship between the white smoke concentration and the non-fuel injection time tq as well as the relationship between the non-fuel injection time tq and the coolant water temperature Tw.

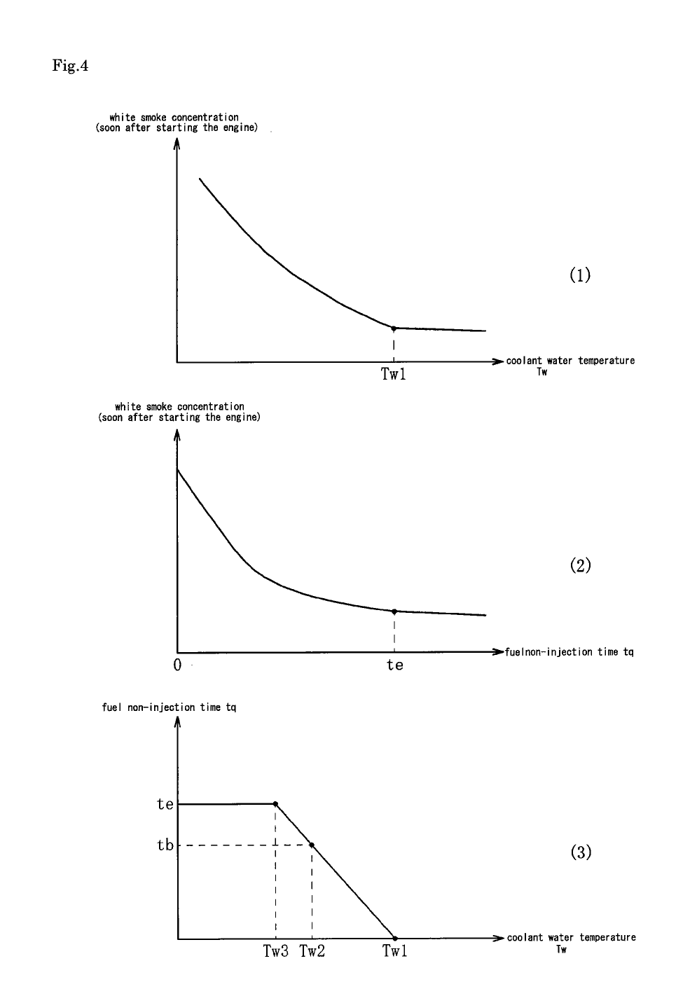

FIG. 4 (1) is a diagram illustrating a relationship between white smoke concentration and coolant water temperature Tw in the conventional fuel injection control device for the diesel engine. FIG. 4 (2) is a diagram illustrating a relationship between the white smoke concentration and the non-fuel injection time tq. FIG. 4 (3) is a diagram illustrating a relationship between the non-fuel injection time tq and the coolant water temperature Tw.

Referring to FIG. 4 (1), the white smoke concentration of the white smoke generated soon after starting the engine is used as the axis of ordinate, and the coolant water temperature Tw detected at the Step S 102 as shown in FIG. 2 is used as the axis of abscissas. The white smoke concentration is not really varied when the coolant water temperature Tw is Tw1 or higher, and it becomes higher as the coolant water temperature Tw becomes lower at the area where the coolant water temperature Tw is lower than Tw1. Therefore, when the non-fuel injection time tq is set up at the area where the coolant water temperature Tw is lower than Tw1, the white smoke generated immediately after starting the engine can be effectively reduced.

Referring to FIG. 4 (2), the white smoke concentration of the white smoke generated soon after starting the engine is used as the axis of ordinate, and the non-fuel injection time tq set up at the Step S 103 as shown in FIG. 2 is used as the axis of abscissas. The non-fuel injection time tq is set up, whereby the white smoke concentration is reduced. The white smoke concentration is reduced as the non-fuel injection time tq becomes longer and is substantially constant from the time when the non-fuel injection time tq becomes te.

Referring to FIG. 4 (3), the non-fuel injection time tq set up at the Step S 103 as shown in FIG. 2 is used as the axis of ordinate, and the coolant water temperature Tw detected at the Step S 102 as shown in FIG. 2 is used as the axis of abscissas. Because when the coolant water temperature Tw is Tw1 or higher in FIG. 4 (1), the white smoke concentration not really varied, the non-fuel injection time tq may set up at zero when the coolant water temperature Tw is Tw1 or higher. Because the white smoke concentration is substantially constant from the time when the non-fuel injection time tq becomes te in FIG. 4 (2), the non-fuel injection time tq may be constantly set up at the te when the when the coolant water temperature Tw is Tw3 or lower. When the coolant water temperature Tw is Tw2, the non-fuel injection time tq becomes the continuous cranking available time tb, and when the coolant water temperature Tw detected at the Step S 102 is Tw2 or lower, the engine is restarted, so that the non-fuel injection time tq is newly set up.

As seen from the above, in the fuel injection control device 20 in which the first fuel injection command is performed after the lapse of the non-fuel injection time tq as shown in the flow diagram of FIG. 2, since the temperature in the combustion chamber is increased due to the cranking during the non-fuel injection time tq, and the rail pressure of the common rail 24 is increased during the non-fuel injection time, the fuel having no contribution to the combustion accumulated into the combustion chamber at the first fuel injection can be decreased, and a large amount of white smokes generated just after starting the engine can be reduced. As shown in the time chart of FIG. 3, the ignition and the first fuel injection can be performed from the fuel injection command due to the energization to the solenoid valve 28. Moreover, as the non-fuel injection time tq is set up depending on the coolant water temperature Tw as one of the engine temperature (S 103 in FIG. 2), the generation of the white smoke is reduced and the optimal engine starting time is set up, so that the engine can be efficiently started. In the above-mentioned fuel injection control, the cranking is not continuously performed at the non-fuel injection state, beyond the continuous cranking available time tb. Accordingly, as the battery power is not rapidly decreased and constant, as well as the continuous operating time of the starter 44 is not the predetermined time or longer, burdens on the battery and the starter 44 can be lowered.

Since re-cranking is repeated until the engine starting when the engine automatic restarting is set up (Yes, S 114 in FIG. 2), the operator needs not turn on the engine staring switch again and again, whereby the usability is improved. The fuel injection command is issued to the injector 26 attached to the cylinder engine having the highest intake air temperature. Consequently, since the first fuel injection is easy to be performed and compression end temperature of cylinder in which the fuel is secondly injected is increased due to the torque by the cylinder that the fuel has been firstly injected, the ignition is enhanced, the fuel having no contribution to the combustion accumulated into the combustion chamber can be further decreased and the large amount of white smokes generated soon after starting the engine can be further reduced.

Next, explanation will be given on a target pressure arrival time of the rail pressure in the common rail 24 using the non-fuel injection time tq.

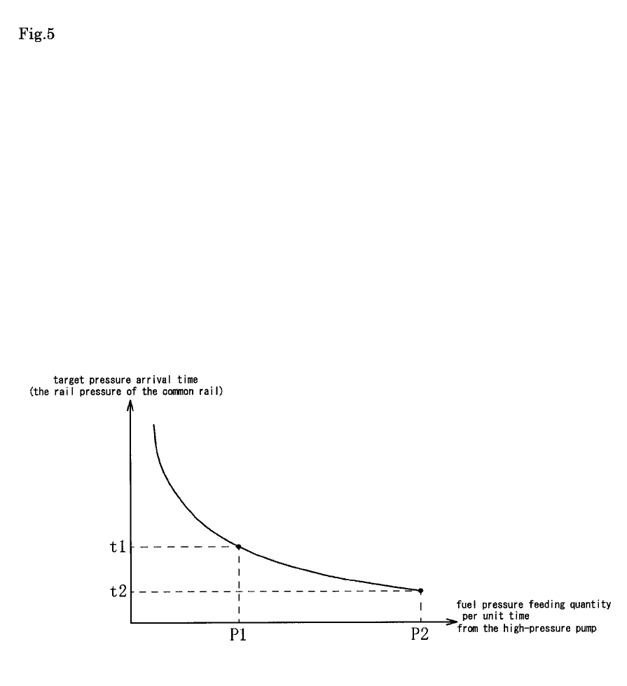

FIG. 5 is a diagram illustrating a relationship between a target pressure arrival time of the rail pressure in the common rail 24 and the fuel pressure feeding quantity per unit time from the high-pressure pump 22.

Referring to FIG. 5, the target pressure arrival time of the rail pressure in the common rail 24 is used as the axis of ordinate, and the fuel pressure feeding quantity per unit time from the high-pressure pump 22 is used as the axis of abscissas. It is illustrated that as the target pressure arrival time becomes shorter, the fuel pressure feeding quantity per unit time from the high-pressure pump 22 becomes larger. In the conventional fuel injection control device for the diesel engine, in order to increase the rail pressure in the common rail 24 at the time of starting the engine, the fuel pressure feeding quantity per unit time from the high-pressure pump is set up to be maximized immediately after the cranking. For example, this is in the case when the target pressure arrival time is t2 and the fuel pressure feeding quantity per unit time is P2. Compared with this, in the fuel injection control device 20 having the non-fuel injection time tq, the target pressure arrival time of the rail pressure in the common rail 24 can be set up to be longer using the non-fuel injection time tq. For example, this can be achieved if the time until the fuel injection command including the non-fuel injection time tq is performed is defined as the target pressure arrival time t1 and in the meantime the rail pressure in the common rail 24 reaches the target pressure. At this time, the fuel pressure feeding quantity per unit time is P1 can be much more reduced than the conventional quantity per unit time P2. Therefore, as the fuel pressure feeding quantity supplied from the high-pressure pump 22 to the common rail 24 soon after starting the cranking needs not to be maximized, the driving force of the high-pressure pump 22 needed soon after starting the cranking can be lowered. The burden on the starter 44 can be reduced, thereby increasing the cranking rotation speed.

In this regard, in the aforementioned embodiment, the non-fuel injection time is set up corresponding to the coolant water temperature, but it may be set up to be constant with limit of the continuous cranking available time.

In the aforementioned embodiment, also, the coolant water temperature is used as the engine temperature, but the intake temperature, lubricant oil temperature or the fuel temperature or the liked may be available, as far as it can be used so as to evaluate the engine temperature, and a combination thereof including the coolant water temperature may be also used.

Further, in the aforementioned embodiment, although six injectors are used, one or more injectors may be used.

Next, the second embodiment of the fuel injection control at the time of starting the engine will be described.

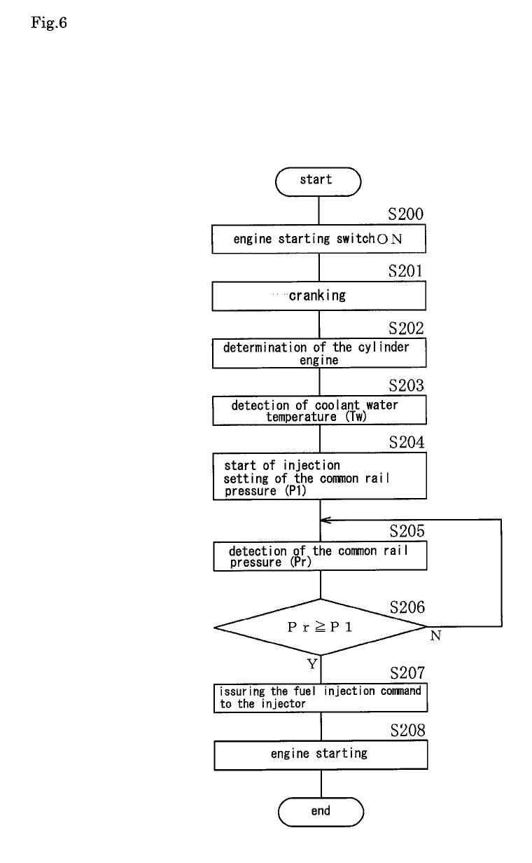

FIG. 6 is a flow diagram illustrating a behavior of a fuel injection control according to the second embodiment of the present invention.

Referring to FIG. 6, when turning on the engine starting switch such as the starter 33 (S200), the cranking is started (S201). The ECU 32 determines the cylinder engine that the fuel should be firstly injected by the signal from the cylinder engine determining sensor 34 (S202). Then, the ECU 32 detects the coolant water temperature Tw as the engine temperature by the signal from the coolant water temperature sensor 40 (S203). The ECU 32 sets up the common rail pressure P1 capable of starting the fuel injection, based on the coolant water temperature Tw detected at the Step S 203 (S204). The ECU 32 detects the present common rail pressure Pr by the signal from the rail pressure sensor 30 (S205). The ECU 32 evaluates whether the common rail pressure Pr detected at the Step S 205 is the common rail pressure P1 set up at the Step S 104 or higher (S206). When Pr is P1 or higher than P1 (Pr≧P1) (Yes, at S 206), the ECU 32 issues the first fuel injection command to the injector 26 (S207). The fuel injection starts by energizing the solenoid valve 28 of the injector 26, whereby the engine is started (S208). When Pr is smaller than P1 (Pr<P1) at the Step S 206, the ECU 32 detects the common rail pressure Pr, returning to the Step S 205 again.

Here, explanation will be given on a relationship between the common rail pressure, the energization of the solenoid valve and the opening/closing of the needle valve at the time of starting the engine.

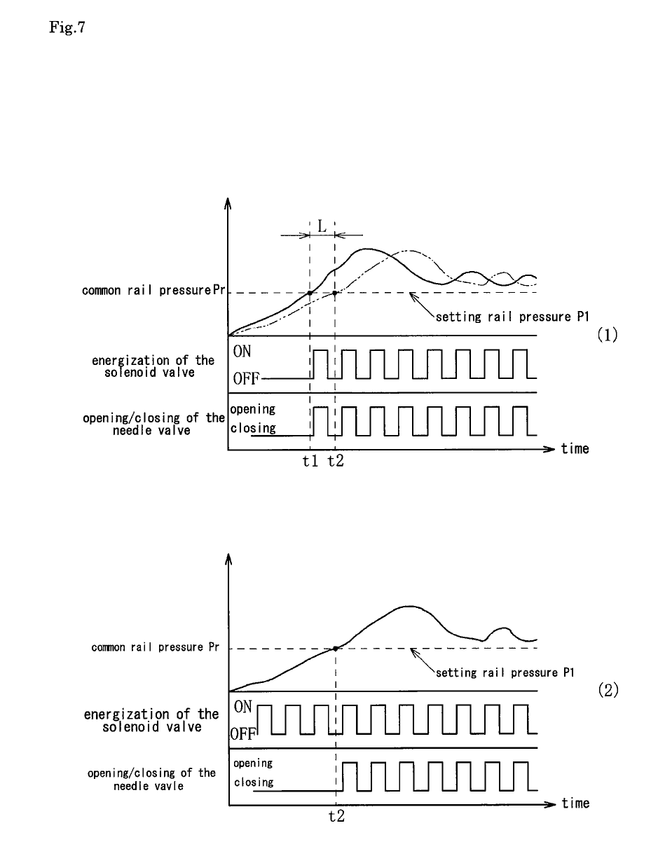

FIG. 7 is a diagram illustrating a relationship between the common rail pressure Pr, the energization of the solenoid valve and the opening/closing of a needle valve as well as time, wherein FIG. 7 (1) is a diagram in the fuel injection control device for the diesel engine as shown in FIG. 1 and FIG. 7 (2) is a diagram in the conventional fuel injection control device for the diesel engine.

Referring to FIG. 7 (1), the common rail pressure Pr at the time of starting the engine is used as the axis of ordinate, and the lapse time is used as the axis of abscissas. The On/OFF state of the solenoid valve and the opening/closing state of the needle valve are illustrated below the diagram which shows the time passage of the common rail pressure Pr. The common rail pressure P1 capable of starting the fuel injection set up at the above-mentioned Step S 204 is shown with a dotted line. The common rail pressure reaches the setting rail pressure P1 at the time t1 and then the solenoid valve is energized, so as to open the needle valve. The number of energization to the solenoid valve coincides with the number of opening the needle valve from the beginning.

Meanwhile, referring to FIG. 7 (2), in case of the conventional fuel injection control device, because the fuel injection starting command is issued from the ECU 32 soon after the cranking, the solenoid valve is energized before the time t2 when the common rail pressure Pr reaches the pressure P1 capable of starting the fuel injection. However, since the common rail pressure Pr does not reach the pressure P1 capable of injecting the fuel, the needle valve is not opened due to the lack of pressure. Therefore, the number of energization to the solenoid valve does not coincide with the number of opening the needle valve.

Returning to FIG. 7 (1), the time passage of the common rail pressure Pr in the conventional fuel injection control device as illustrated in FIG. 7 (2) is shown with a two-dot chain line. In the fuel injection control device 20, it is indicated that the engine starting time is accelerated by the time L, compared with the conventional fuel injection control device. This means that as the needle valve 29 is not opened but the solenoid valve 28 is energized and opened in the conventional fuel injection control device, the fuel is leaked from the injector 26 to the surplus fuel pipe 27, so that the time until the common rail pressure Pr reaches the injectable setting rail pressure P1 becomes longer.

Explanation will be given on the relationship between the setting rail pressure P1 and the coolant water temperature Tw as well as the white smoke concentration and the coolant water temperature Tw.

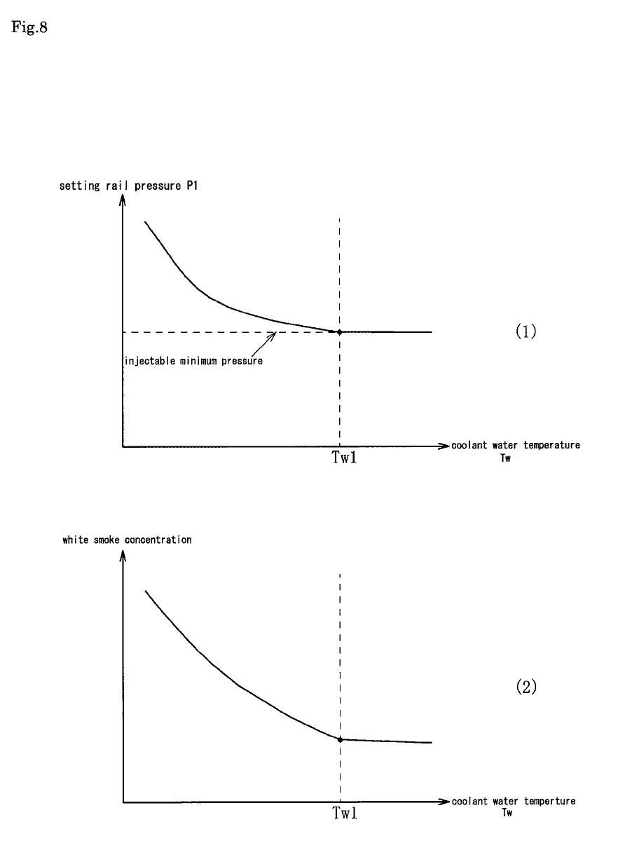

FIG. 8 (1) is a diagram illustrating a relationship between the setting rail pressure P1 and the coolant water temperature Tw as shown in FIG. 6. FIG. 8 (2) is a diagram illustrating a relationship between the white smoke concentration and the coolant water temperature Tw in the conventional fuel injection control device for the diesel engine.

Referring to FIG. 8 (1), the setting rail pressure P1 capable of starting the fuel injection in the common rail 24 set up at the Step S 204 is used as the axis of ordinate, and the coolant water temperature Tw detected at the Step S 203 is used as the axis of abscissas. The setting rail pressure P1 is approximately constant at the injectable minimum pressure when the coolant water temperature Tw is Tw1 or higher. The setting rail pressure P1 is set up higher as the coolant water temperature Tw becomes lower when the coolant water temperature Tw is lower than Tw1.

Referring to FIG. 8 (2), the white smoke concentration of the white smoke generated just after starting the engine is used as the axis of ordinate, and the coolant water temperature Tw detected at the Step S 203 is used as the axis of axis of abscissas. The white smoke concentration is not really varied when the coolant water temperature Tw is Tw1 or higher, and it becomes higher as the coolant water temperature Tw become lower when the coolant water temperature Tw is lower than Tw1. Therefore, when the coolant water temperature Tw is lower than Tw1, the white smoke concentration of the white smoke generated just after starting the engine can be reduced by increasing the setting rail pressure P1.

As seen from the above, in the fuel injection control device 20, which the first fuel injection command just after the cranking is issued to the injector 26 after the common rail pressure Pr reaches the setting rail pressure P1 as shown in the flow diagram of FIG. 6, the fuel having no contribution to the combustion caused by the lack of rail pressure is not accumulated into the combustion chamber, so that the a large amount of white smokes generated immediately after starting the engine can be reduced. The amount of fuels leaked from the injector 26 is decreased, and the time when the rail pressure reaches the pressure capable of injecting the fuel is shortened, thereby being able to shorten the engine starting time. Because the setting rail pressure P1 is varied depending on the coolant water temperature Tw as one of the engine temperature, the generation of the white smoke is reduced and the optimal engine starting time is set up, whereby the efficient engine starting can be performed.

In this regard, in the aforementioned embodiment, the setting rail pressure is set up depending on the coolant water temperature, but it may be constantly set up.

In the aforementioned embodiment, also, coolant water temperature is used as the engine temperature, but the intake temperature, lubricant oil temperature or the fuel temperature or the liked may be available, as far as it can be used so as to evaluate the engine temperature, and a combination thereof including the coolant water temperature may be also used.

Further, in the aforementioned embodiment, although six injectors are used, one or more injectors may be used.

### INDUSTRIAL APPLICABILITY

The present invention is applicable in the fuel injection control device for the diesel engine, especially in the fuel injection control device for the diesel engine controlling the first fuel injection command soon after the cranking at the time of starting the engine.

### DESCRIPTION OF NOTATIONS

20 a fuel injection control device
22 a high-pressure pump
24 a common rail
26 an injector
44 a starter

1. A fuel injection control device for a diesel engine, comprising of:
a high-pressure pump,
a common rail for accumulating highly-pressured fuel pressurized and sent from the high-pressure pump,
injectors for injecting the fuel supplied from the common rail into a combustion chamber, and
a control means for controlling the injectors to perform the first fuel injection command soon after a cranking, after a rail pressure of the common rail reaches a predetermined pressure.

2. The fuel injection control device for the diesel engine as set forth in claim 1, further comprising of:
a detecting means for detecting an engine temperature, and
a setting means for setting up the predetermined pressure based on the detected engine temperature.

3. The fuel injection control device for the diesel engine as set forth in claim 2, wherein the engine temperature is calculated based on at least a coolant water temperature of the engine.

4. The fuel injection control device for the diesel engine as set forth in claim 1, further comprising of:
a starter starting an operation by turning on an engine starting switch,
a setting means for setting up a non-fuel injection time when the cranking is continuously performed by the starter using a battery power, and
a control means for controlling the injectors to perform the first fuel injection command after the lapse of the non-fuel injection time.

5. The fuel injection control device for the diesel engine as set forth in claim 4, further comprising of:
a detecting means for detecting the engine temperature,
wherein the non-fuel injection time is set up based on the detected engine temperature.

6. The fuel injection control device for the diesel engine as set forth in claim 5, wherein the engine temperature is calculated based on at least the coolant water temperature.

7. The fuel injection control device for the diesel engine as set forth in claim 4, wherein when the non-fuel injection time is longer than the continuous cranking available time, the cranking is performed without injecting the fuel during the continuous cranking available time and wherein the setting means newly sets up the non-fuel injection time after the cranking is stopped.

8. The fuel injection control device for the diesel engine as set forth in claim 7, wherein re-cranking performed during the non-fuel injection time newly set up is automatically started.

9. The fuel injection control device for the diesel engine as set forth in claim 4, wherein the fuel injection command is issued to the injector attached to the cylinder engine having the highest intake air temperature.

10. The fuel injection control device for the diesel engine as set forth in claim 4, wherein pressure feeding quantity of the fuel pressurized and sent from the high-pressure pump per unit time is reduced, so that the time until the fuel injection command is issued approximately coincides with the one until the rail pressure of the common rail reaches a target pressure.

11. The fuel injection control device for the diesel engine as set forth in claim 4, wherein the setting means and the control means are set up so as not to be performed, when voltage of the battery is a predetermined value or lower.
